(19) United States
(12) Patent Application Publication
(10) Pub. No.: US 2004/0057365 A1
(43) Pub. Date: Mar. 25, 2004

(54) Method and apparatus for detecting blank region of optical storage medium

(75) Inventors: Chien-Ming Chen, Hsin-Chu City (TW); Ching-San Wu, Hsin-chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/453,628

(22) Filed: Jun. 4, 2003

(30) Foreign Application Priority Data
Sep. 19, 2002 (CN) 091121403

(51) Int. Cl. G11B 7/00

(52) U.S. Cl. 369/53.24

(57) ABSTRACT

The present invention provides a detecting method for effectively detecting blank regions on an optical storage medium. The detecting method is to detect the radio frequency (RF) waveform from the optical storage medium. The RF waveform comprises a plurality of sinewaves with different frequencies. The amplitudes of the sinewaves are selectively boosted with different boost gains depending on the frequencies of the sinewaves to obtain a corresponding gain boost signal. The gain boost signal is judged with a predetermined blank judging interval. When the present amplitudes of the gain boost signal fall within the blank judgment interval, the RF waveform is deemed detected from the blank regions of the optical storage medium.

### BACKGROUND OF THE INVENTION

1. Field of the Invention

This present invention relates to a detection apparatus and a method for detecting blank regions which have not yet recorded data on an optical storage medium.

2. Description of the Prior Art

While recording data onto an optical storage medium by a driving device of optical storage mediums, it is necessary to be able to discriminate the blank regions which have not yet recorded data thereon from the data recording regions which have recorded data thereon, so as to easily control the relative activities of each component in the driving device and determine regions for recording. The prior art usually utilizes the peak/bottom detection method or slicing level detection method to detect blank regions on an optical storage medium.

Please refer to FIG. 1. FIG. 1 is a schematic diagram of a driving device 01 recording/reproducing data on an optical storage medium 14. The driving device 01 comprises a light generator 10 and an sensing module 16. According to the prior art, when the peak/bottom detection method is used to detect blank regions of the optical storage medium 14, the light generator 10 generates a laser beam 12 irradiating to the optical storage medium 14 and the sensing module 16 is used for receiving the laser beam reflected from the optical storage medium 14 then transforming the reflected laser beam 12 into an electronical signal 18 to be transmitted forward to a detection device 20. The electronical signal 18, which is transformed from the reflected laser beam 12, is generally called radio frequency (RF) signal.

Please refer to FIG. 2 and FIG. 3. FIG. 2 is a block diagram of the detection apparatus 20 shown in FIG. 1. FIG. 3 is a schematic diagram of detecting a RF waveform 08 by the peak/bottom detection method according to the prior art. In the detection apparatus 20, a peak/bottom detection circuit 02 is used to detect the amplitude of the electronical signal 18, and the electronical signal 18 is the RF waveform as shown in FIG. 3. The peak/bottom detection circuit 02 uses a sampling clock 04 for sampling the amplitude of the RF. Then during every time unit, a pre-set threshold value 22 is used as a reference base and a comparator 06 is used to compare the sampled amplitude with the reference base to see whether the sampled amplitude is under or below the pre-set threshold value 22. The RF is deemed to be from the blank regions of the optical storage medium which have not yet recorded data thereon, if the amplitude is below the pre-set threshold value 22. Otherwise the RF is deemed to be from the data recording regions which have recorded data thereon.

However, it takes time for sampling, and judgment delay may happen because of time lag. When the detection is from a blank region into a data recording region, the signal is actually in the data recording region. Due to the next sampling time is not yet coming, the amplitude information is therefore not yet updated. In such situation, the comparator 06 still uses the former amplitude information to compare with the pre-set threshold value 22. Hence the detection apparatus 20 will judge that the optical storage medium 14 is still in a blank region, resulting in a misjudgment.

FIG. 4 is a block diagram of an alternative detecting apparatus 48 in the driving device 01 shown in FIG. 1. FIG. 5 is a schematic diagram of detecting the RF waveform 08 by the slicing level detecting method according the prior art. The prior art slicing level detecting method can avoid delays of judgment resulted from time lag of sampling as mentioned above. As shown in FIG. 1 and FIG. 4, the laser beam 12 is transformed to be the electronical signal 18 (not shown in FIG. 1) and then transmitted into the detecting apparatus 48. In the detecting apparatus 48, a waveform detection module 36 is used to detect the RF waveform 08 detected from the optical storage medium 14. Then a predetermined slicing level 30 and a blank judgment interval are selected as a reference base. The upper and lower limits of the blank judgment interval are defined by a positive hysteresis level (PHL) 38 and a negative hysteresis level (NHL) 40. And the distances from the PHL 38 to the slicing level 30 and from the NHL 40 to the slicing level 30 are the same. Then a blank region judgment module 42 is used to judge that whether the waveform 08 is between NHL 40 and PHL38, i.e., within the blank judgment interval. If yes, it means the RF detected by the waveform detection module 36 is from the blank regions. Otherwise, it means the RF detected by the waveform detection module 36 is from the data recording regions.

However, the RF waveform potentially comprises background noises 44 and a plurality of different frequency sinewaves 46, wherein the higher the frequency sinewave is, the smaller the amplitude is. If the distances of the slicing level 30 to the PHL 38 and the NHL 40 are defined too narrow, the background noises 44 are easily misjudged as the RF from the data recording regions. If the distances of the slicing level 30 to the PHL 38 and to the NHL 40 are defined too spacious, many RF from data recording regions are easily misjudged as the RF from the blank judgment interval, because their amplitudes of sinewave 46 are not enough and fall into the blank judgment interval.

Hence the main objective of the present invention is to provide a method and an apparatus to solve these problems as mentioned above.

### SUMMARY OF THE INVENTION

The main objective of the present invention is providing a detection apparatus and method for detecting blank regions which have not yet recorded data on an optical storage medium.

The optical storage medium contains data recording regions and blank regions. The data recording regions have recorded a plurality of data thereon, and the blank regions are regions have not yet recorded data thereon. The detecting apparatus comprises a waveform detection module for detecting a RF waveform from the optical storage medium. The RF waveform potentially comprises background noises and a plurality of different frequency sinewaves, wherein the higher the frequency sinewave is, the smaller the amplitude is. The detecting apparatus also comprises a selective gain boost module for selectively boosting the amplitudes of the sinewaves with different boost gains according to the respective frequencies of the input sinewaves in the RF waveform, and obtaining a corresponding gain boost signal.

The detecting apparatus also comprises a blank region judgment module for judging the present gain boost signal with a predetermined blank judgment interval. When the present amplitudes of the gain boost signal fall within the blank judgment interval, the RF waveform detected by the waveform detection module is deemed from the blank regions. Otherwise the RF waveform detected by the waveform detection module is deemed from the data recording regions.

The detecting apparatus of the present invention can precisely detect the blank region which have not yet recorded data on an optical storage medium and further reduce potential misjudgment.

These and other objective of the present invention will no doubt become obvious to those of ordinary skill in the art after reproducing the following detailed description of the preferred embodiment which is illustrated in the various figures and drawings.

### BRIEF DESCRIPTION OF THE APPENDED DRAWINGS

FIG. 1 is the schematic diagram of a prior art driving device of optical storage medium, which is recording and reproducing data from an optical storage medium.

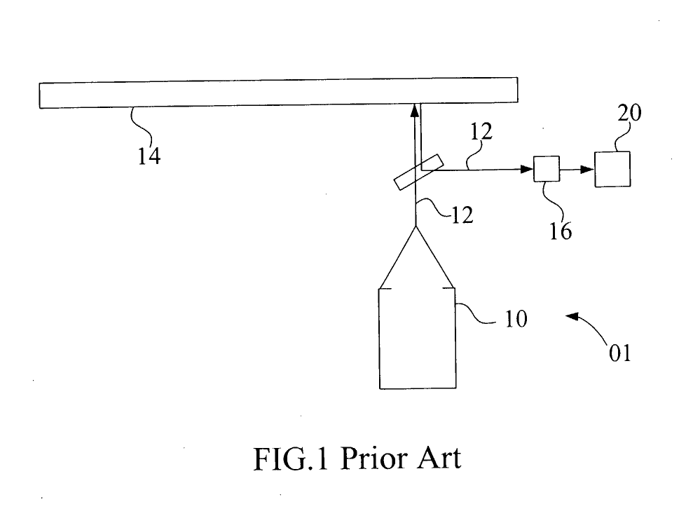

FIG. 2 is the block diagram of the detecting apparatus as FIG. 1 shows.

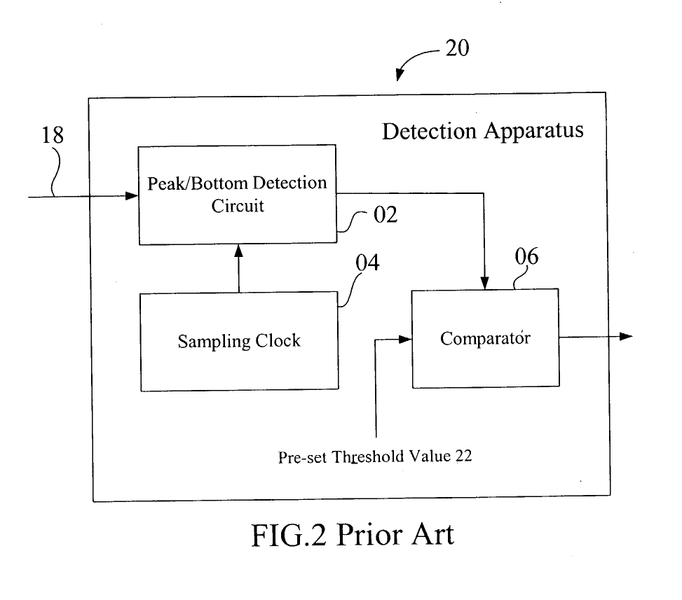

FIG. 3 is the schematic diagram of prior art peak/bottom detection method to detect the RF waveforms.

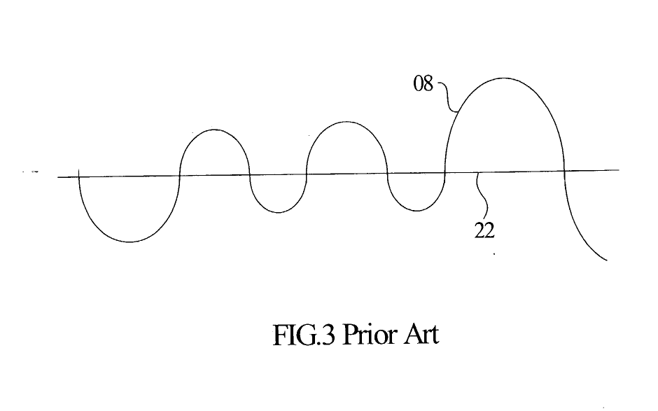

FIG. 4 is the block diagram of a detecting apparatus for another implementation example of the driving device of optical storage medium.

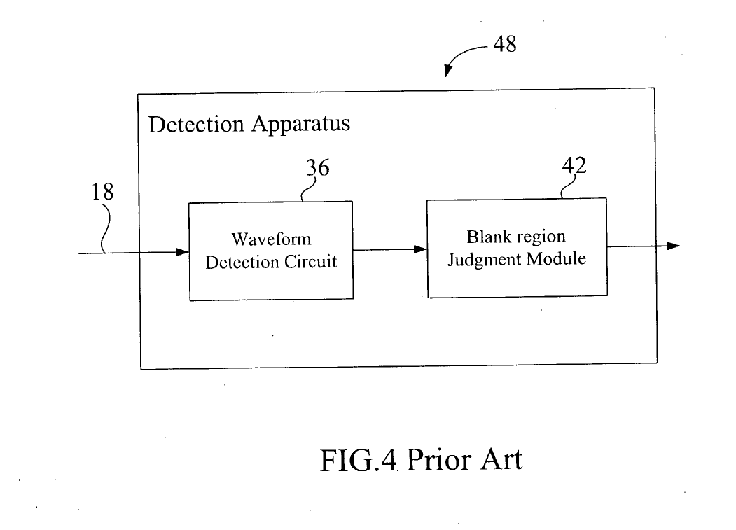

FIG. 5 is the schematic diagram of the prior art slicing level detecting method to detect the RF waveforms.

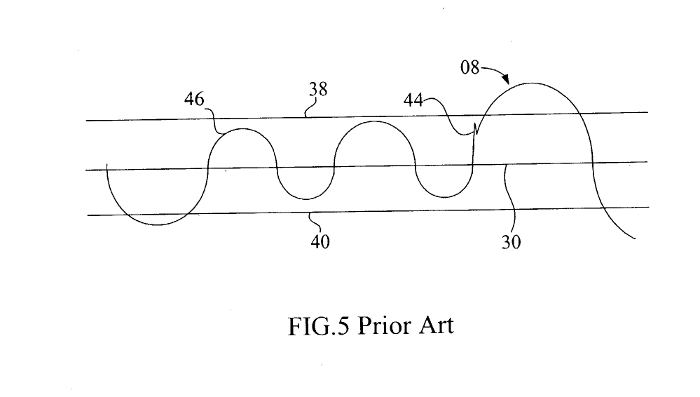

FIG. 6 is the block diagram of the detecting apparatus of the present invention.

FIG. 7 is a signal relationship diagram for the detecting apparatus to detect blank regions according to a predetermined slicing level.

FIG. 8 is the flowchart for the detecting method of the detecting apparatus as FIG. 6 shows.

### DETAILED DESCRIPTION OF THE PREFERRED EMBODIMENT

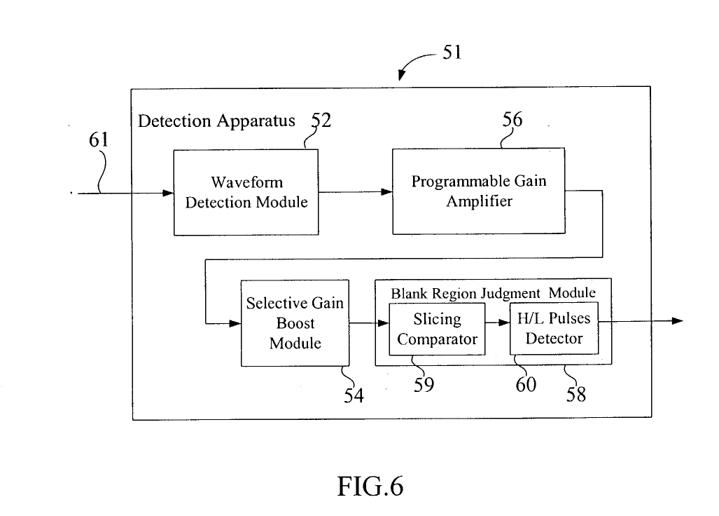

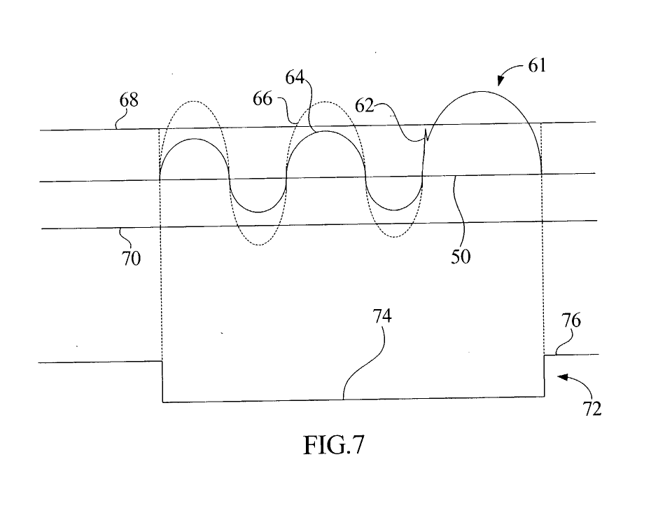

Please refer to FIG. 6 and FIG. 7. FIG. 6 is a block diagram of a detecting apparatus 51 of the present invention. FIG. 7 is a schematic diagram of the signals when the detecting apparatus 51 using a predetermined slicing level 50 to detect blank regions. The present invention provides a detecting apparatus 51 for detecting blank regions on an optical storage medium. The optical storage medium (not shown in figures) contains data recording regions and blank regions. The data recording regions are regions on the optical storage medium which have recorded a plurality of data thereon. The blank regions are regions on the optical storage medium which have not yet recorded data thereon.

The detecting apparatus 51 comprises a waveform detection module 52, a programmable gain amplifier 56, a selective gain boost module 54 and a blank region judgment module 58.

The waveform detection module 52 is for detecting a RF waveforms 61 from the optical storage medium. The RF waveform 61 potentially comprises background noises 62 and a plurality of different frequency sinewaves 64. Meanwhile a fact exists that the higher the frequency is, the smaller the amplitude is for any sinewave 64 of RF waveform 61 detected from the optical storage medium. The programmable gain amplifier 56 is for amplifying the RF waveform 61 detected by the waveform detection module 52, and then outputting the amplified waveform to the selective gain boost module 54.

The selective gain boost module 54 is for selectively boosting the amplitudes of the sinewave 64 with different boost gains according to the respective frequencies of the input sinewaves 64 in the RF waveform 61, and then obtaining a corresponding gain boost signal 66. The higher frequency the sinewave 64 is, the bigger gain the amplitude needs. Generally speaking, the gain from the selective gain boost module 54 is substantially from 3 dB to 13 dB.

The blank region judgment module 58 is for judging the present gain boost signal 66 according to a predetermined blank judgment interval. The PHL 68 and NHL 70 define the upper and lower limits of the blank judgment interval, respectively. When the present amplitudes of the gain boost signal 66 fall within the blank judgment interval, the RF waveform 61 detected by the waveform detection module 52 is deemed from the blank regions, otherwise the RF waveform 61 detected by the waveform detection module 52 is deemed from the data recording regions. The selective gain boost module 54 will boost the amplitude of the input sinewave 64 of the RF waveform 61 which has higher frequency over the PHL 68 and the NHL 70. When the RF waveform 61 is detected from the data recording region, the RF waveform 61 comprises background noises 62 and a plurality of different frequency sinewaves 64. When the RF waveform 61 is detected from the blank regions, the RF waveform 61 comprises only background noises 62 but no sinewaves 64.

The blank region judgment module 58 will generate a corresponding judgment signal 72, so-called blank flag that is commonly known in the art. The judgment signal 72 comprises a first judgment level 74 and a second judgment level 76. When the amplitude of the present gain boost signal 66 is beyond the blank judgment interval, the judgment signal 72 is situated in the first judgment level 74, wherein the first judgment level 74 represents the data recording regions on an optical storage medium. When the amplitude of the present gain boost signal 66 is within the blank judgment interval, the judgment signal 72 is situated in the second judgment level 76, wherein the second judgment level 76 represents the blank regions on an optical storage medium.

As the FIG. 6 shows, the blank region judgment module 58 comprises a slicing comparator 59 and a H/L pulses detector 60. The slicing comparator 59 is for setting the blank judgment interval on a predetermined slicing level, slicing the present gain boost signal 66. The H/L pulses detector 60 will determine whether the judgment signal 72 should be situated in the first judgment level 74 or the second judgment level 76 by the result of the slicing comparator, and determining whether the RF waveform 61 detected by the waveform detection module 52 is from the data recording regions or the blank regions.

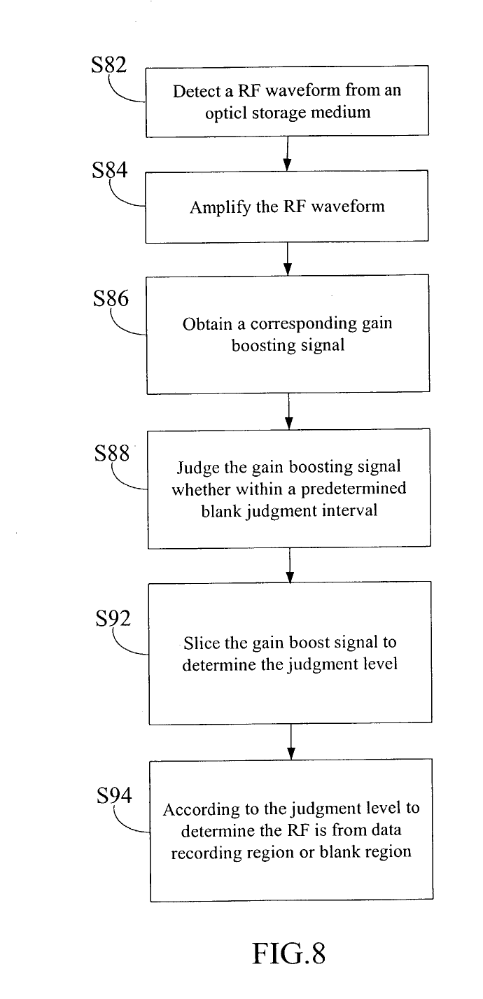

Please refer to FIG. 8. FIG. 8 is a flow chart for the detecting method of the detecting apparatus 51 shown in FIG. 6. The detecting method of the present invention comprises the following steps:

Step S82: detecting the RF waveform 61 from the optical storage medium;

Step S84: amplifying the RF waveform 61 detected;

Step S86: selectively boosting the amplitudes of the sinewaves 64 with different boost gains according to the respective frequencies of the sinewaves 64 in the RF waveform 61 to obtain a corresponding gain boost signal 66;

Step S88: judging the present gain boost signal 66 whether it is within a predetermined blank judgment interval;

Step S92: slicing the present gain boost signal 66 according to the blank judgment interval on a predetermined slicing level to determine whether the judgment signal 72 should be situated in the first judgment level 74 or the second judgment level 76;

Step S94: determining the RF is from the data recording regions or the blank regions according to whether that the judging signal 72 is situated in the first judging level 74 or the second judging level 76.

When the amplitude of the present gain boost signal 66 within the blank judgment interval, it means that the RF waveform 61 detected by the waveform module 52 is from the blank regions, otherwise the RF waveform 61 detected by the waveform module 52 is from the data recording regions. Therein the input amplitude of the sinewaves 64 of the input RF waveform 61 which has higher frequencies is boosted over the extent of the blank judgment interval, namely over the PHL 68 and NHL 70. When the RF signal is reproduced from the data recording regions, the RF signal comprises background noises 62 and different frequency sinewaves 64. When the RF signal is reproduced from the blank regions, the RF signal comprises only background noises 62 but no sinewaves 64.

Please refer to FIG. 7. A corresponding judgment signal 72 is generated. The judgment signal 72 comprises a first judgment level 74 and a second judgment level 76. When the amplitude of the present gain boost signal 66 is over the blank judgment interval, the judgment signal 72 will be situated in the first judgment level 74. When the amplitude of the gain boost is within the blank judgment interval, the judgment signal 72 will be situated in the second judgment level 76.

Hence the present invention provides a detecting apparatus 51 and a detecting method for detecting blank regions which have not yet recorded data on an optical storage medium. The detecting method is to detect a RF waveform 61 from the optical storage medium, wherein the RF waveform 61 comprises a plurality of different frequency sinewaves 64, and then to selectively boost the amplitude of sinewaves 64 by different boost gain according to the different frequency of sinewave 64 of the RF waveform 61 to obtain a corresponding gain boost signal 66, and further to judge the present gain boost signal with a predetermined blank judgment interval. When the amplitude of the present gain boost signal is within the blank judgment interval, it means the RF signal detected by the waveform detection module 52 is from the blank regions. Whereby, the method of the present invention can more precisely detect the blank regions which have not yet recorded data thereon of the optical storage medium.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A detection apparatus for detecting blank regions of an optical storage medium containing data recording regions and blank regions, the data recording regions being regions in the optical storage medium, which have recorded a plurality of data thereon, and the blank regions being regions in the optical storage medium, which have not yet recorded data thereon, the detection apparatus comprising:
a waveform detection module for detecting a radio frequency (RF) waveform from the optical storage medium, the RF waveform potentially comprising background noises and a plurality of different frequency sinewaves, wherein the higher the frequency sinewave is, the smaller the amplitude is;
a selective gain boost module for selectively boosting the amplitudes of the sinewaves with different boost gains according to the respective frequencies of the input sinewaves in the RF waveforms, and obtaining a corresponding gain boost signal; and
a blank region judgment module for judging the present gain boost signal with a predetermined blank judgment interval, wherein when the present amplitudes of the gain boost signal fall within the blank judgment interval, the RF waveform detected by the waveform detection module is deemed from the blank regions, otherwise the RF waveform detected by the waveform detection module is deemed from the data recording regions.

2. The detection apparatus of claim 1, wherein the upper and lower limits of the blank judgment interval are defined by a positive hysteresis level (PHL) and a negative hysteresis level (NHL).

3. The detection apparatus of claim 2, wherein the selective gain boost module boosts the amplitudes of the input sinewaves which have higher frequencies over the PHL and the NHL.

4. The detection apparatus of claim 1, wherein when the RF waveform is detected from the data recording regions, the RF waveform comprises background noises and different frequency sinewaves, and when the RF waveform is detected from the blank regions, the RF waveform comprises only background noises but no frequency sinewaves.

5. The detection apparatus of claim 1, wherein the detection apparatus further comprises a programmable gain amplifier for amplifying the RF waveform detected by the waveform detection module, and then outputting to the selective gain boost module.

6. The detection apparatus of claim 1, wherein the blank region judgment module generates a corresponding judgment signal comprising a first judgment level and a second judgment level, when the amplitudes of the present gain boost signal is beyond the blank judgment interval, the judgment signal is situated in the first judgment level, and when the amplitudes of the present gain boost signal fall within the blank judgment interval, the judgment signal is situated in the second judgment level.

7. The detection apparatus of claim 6, wherein the blank region judgment module comprises:
a slicing comparator, for setting the blank judgment interval on a predetermined slicing level, slicing the present gain boost signal, and determining whether the judgment signal is situated in the first or the second judgment level; and
a H/L pulses detector, for determining whether the RF waveform detected by the waveform detection module is from the data recording regions or the blank regions according to whether the judgment signal is situated in the first or the second judgment level.

8. The detection apparatus of claim 1, wherein the gain of the selective gain boost module is substantially from 3 dB to 13 dB.

9. A detection method for detecting blank regions of an optical storage medium containing data recording regions and blank regions, the data recording regions being regions in the optical storage medium which have recorded a plurality of data thereon, and the blank regions being regions in the optical storage medium, which have not yet recorded data thereon, the detection method comprising the following steps:
(A) detecting a radio frequency (RF) waveform from the optical storage medium, the RF waveform potentially comprising background noises and a plurality of different frequency sinewaves, wherein the higher the frequency sinewave is, the smaller the amplitude is;
(B) selectively boosting the amplitudes of the sinewaves with different boost gains according to the respective frequencies of the input sinewaves in the RF waveform, and obtaining a corresponding gain boost signal; and
(C) judging the present gain boost signal with a predetermined blank judgment interval, wherein when the present amplitudes of the gain boost signal fall within the blank judgment interval, the RF waveform is deemed detected from the blank regions, otherwise the RF waveform is deemed detected from the data recording regions.

10. The detection method of claim 9, wherein the upper and lower limits of the blank judgment interval are defined by a positive hysteresis level (PHL) and a negative hysteresis level (NHL).

11. The detection method of claim 10, wherein the detection method further boosts the amplitudes of the input sinewaves which have higher frequencies over the PHL and the NHL.

12. The detection method of claim 9, wherein when the RF waveform is detected from the data recording regions, the RF waveform comprises background noises and different frequency sinewaves, and when the RF waveform is detected from the blank regions, the RF waveform comprises only background noises but no frequency sinewaves.

13. The detection method of claim 9, wherein, before step (B), a programmable gain amplifier is further utilized for amplifying the detected RF waveform.

14. The detection method of claim 9, wherein in step (C), a corresponding judgment signal, comprising a first judgment level and a second judgment level, is further generated, and wherein when the amplitudes of the present gain boost signal is beyond the blank judgment interval, the judgment signal is situated in the first judgment level, and when the amplitudes of the present gain boost signal fall within the blank judgment interval, the judgment signal is situated in the second judgment level.

15. The detection method of claim 14, wherein step (C) further comprises the following steps:
setting the blank judgment interval on a predetermined slicing level, slicing the present gain boost signal, and determining whether the judgment signal is situated in the first or the second judgment level; and
determining whether the RF waveform is detected from the data recording regions or the blank regions according to whether the judgment signal is situated in the first or the second judgment level.

16. The detection method of claim 9, wherein the gain in step (C) is substantially from 3 dB to 13 dB.
